(19) United States
(12) Patent Application Publication
(10) Pub. No.: US 2005/0067236 A1
(43) Pub. Date: Mar. 31, 2005

(54) Piezoelectric actuator

(75) Inventors: Roberto Conti, Olgiate Olona (IT); Wilfried Giering, Mendig (DE); Franz Holl, Mastershausen (DE); Dietmar Knoop, Ebenhausen (DE); Denis John Mccann, Rochester Hills, MI (US); Markus Necknig, Waldesch (DE); Paul Anthony Thomas, Caldicot (GB); Andrew Ward, Cottesbrooke (GB)

Correspondence Address: CARLSON, GASKEY & OLDS, P.C., 400 WEST MAPLE ROAD, SUITE 350, BIRMINGHAM, MI, 48009, US

(73) Assignee: Meritor Heavy Vehicle Breaking Systems 9UK) Ltd, Cwmbran (GB)

(21) Appl. No.: 10/250,881

(22) PCT Filed: Jan. 11, 2002
(86) PCT No.: PCT/GB02/00108

(30) Foreign Application Priority Data
Jan. 12, 2001 (GB) 0100860.6

(51) Int. Cl. F16D 55/08; F16D 65/00

(52) U.S. Cl. 188/266.7; 188/72.1; 188/73.1

(57) ABSTRACT

An apparatus for actuating a brake comprising force transmission means for transmitting force to a friction pad of a brake, at least one piezo-electric device operable when energised to change shape and/or size so as to apply a force to the force transmission means in a direction for actuating the brake, and retaining means operable to resist movement of the force transmission means in an opposite direction

The present invention relates to an apparatus for actuating a brake.

A known vehicle brake arrangement comprises a disc fixed for rotation with a wheel and a brake clamping mechanism comprising a tappet which is mechanically actuated to bring brake pads into contact with the disc and to apply a force between the pads and the disc to provide frictional braking.

Piezo-electric devices which change size and/or shape when energised by application of an electric current are known for applying a mechanical actuating force over a short distance.

According to the present invention there is provided an apparatus for actuating a brake comprising force transmission means for transmitting force to a friction pad of a brake, at least one piezo-electric device operable when energised to change shape and/or size so as to apply a force to the force transmission means in a direction for actuating the brake, and retaining means operable to resist movement of the force transmission means in an opposite direction.

Preferably, the retaining means is a ratchet device.

The ratchet device may comprise a mechanical device.

The mechanical device may comprise a ratchet member and a biasing means biasing the ratchet member into engagement with the force transmission means for resisting movement thereof.

The ratchet member may have a sharp edge for engaging the force transmission means.

Preferably, expansion of the piezo-electric device causes the ratchet member to move out of engagement with the force transmission means, and contraction of the piezo-electric device permits the biasing means to move the ratchet member into engagement with the force transmission means.

Conveniently, the apparatus comprises a support and a portion of the force transmission means passes through an opening in the support, the piezo-electric device being interposed between said portion and the support so as to act against the support when applying force to the force transmission means.

Conveniently, the piezo-electric device extends circumferentially around said portion. The piezo-electric device may comprise a plurality of piezo-electric members arranged around said portion.

Preferably, the apparatus comprises at least one oppositely-acting piezo-electric device operable to overcome the biasing force. This permits movement of the force transmission means in the opposite direction for releasing the brake.

Preferably, the oppositely-acting piezo-electric device is also operable to apply force to move the force transmission means in the opposite direction.

Alternatively, the ratchet device comprises at least one further piezo-electric device operable to change shape and/or size so as to continue the application of force to the force transmission means in the direction for actuating the brake.

Conveniently, the apparatus comprises a structural element and a shaft of the force transmission means passes through an opening in the structural element, the or each piezo-electric device being interposed between the shaft and the structural element such that, when energised, the or each piezo-electric device changes shape and/or size so as to act against the structural element and cause force to be applied to the force transmission means in at least one direction.

The direction or directions may be axial and/or tangential and/or radial with respect to the shaft.

Although the distance that the piezo-electric device moves is small, repeated expansion and contraction of the piezo electric device in conjunction with the ratchet device facilitates sustained application of force and/or much greater movement of the force transmission means.

Alternatively, the apparatus comprises a plurality of piezo-electric devices, each device being associated with a respective one of a plurality of device groups, the devices in each group being energisable together, by connection to an oscillating power supply with a phase difference between the supply to associated groups, to change size and/or shape in groups, sequentially, thereby to apply force for actuating a brake.

Braking force may be applied continuously by making use of dynamic response characteristics of piezo-electric devices. Phased expansion of groups permits force applied to be sustained at close to the maximum available from each group because as force applied by a first group starts to diminish, force applied by a second group approaches the maximum.

The piezo-electric device may be operable to be energised by application of an electric voltage controlled by a controller, for example a microprocessor.

The controller may be operable to respond to electrical signals fed back to it from the brake so as to adjust the level of the voltage applied to the piezo-electric device.

Preferably, the controller is also operable to adjust the released position of the force transmission means so as to compensate for wear of the brake pads.

Piezo-electric devices have a rapid response to application of an energising voltage. This facilitates the provision of high frequency application and removal of voltage to provide rapid actuation of the brake. Frictional braking results in the generation of heat, and piezo-electric elements may be selected which retain their operating characteristics over a wide temperature range.

The apparatus described above allows electrical energy to be transformed directly into brake clamping force. A relatively small number of components is required, resulting in a compact, light-weight brake actuator assembly, and reducing manufacturing costs. Energy usage is low as there are few moving components when compared, for example, with electric motor actuators. The use of electrical voltages facilitates rapid and accurate control.

Embodiments of the invention will now be described by way of example, with reference to the accompanying drawings in which:

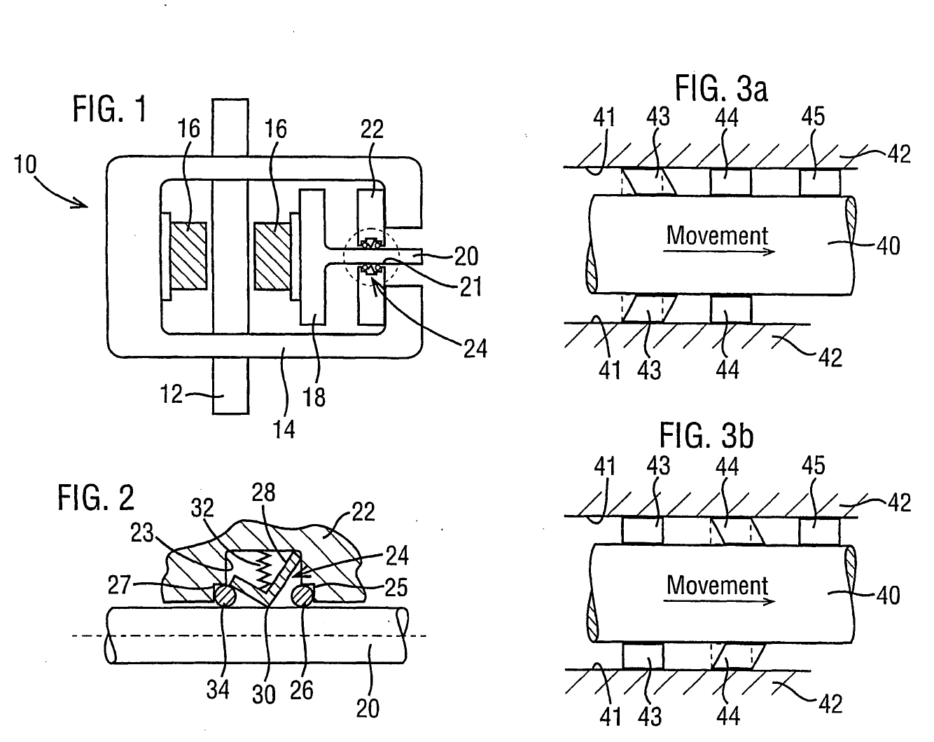

FIG. 1 is a schematic representation of a portion of a brake having an actuator according to a first embodiment;

FIG. 2 shows a detail of the actuator of FIG. 1;

FIGS. 3a and 3b respectively show alternative conditions of a portion of an actuator according to a second embodiment;

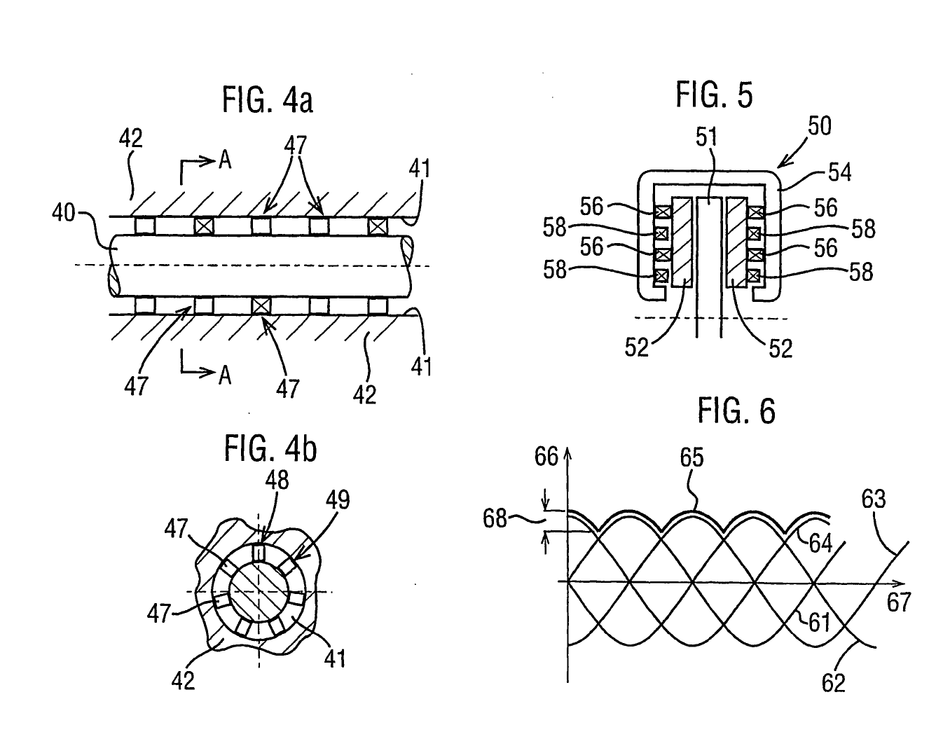

FIG. 4a is a sectional elevation of the actuator of FIGS. 3a and 3b;

FIG. 4b is a cross-sectional view along A-A in FIG. 4a;

FIG. 5 shows a brake having an actuator according to a third embodiment; and

FIG. 6 is a graph showing force applied by the piezo-electric elements of the actuator of FIG. 5 against time.

Referring to FIG. 1, a brake 10 comprises a disc 12 and brake pads 16 operable to clamp the disc 12 to apply a braking force thereto. Brake pads 16 are actuated by force transmission means in the form of a tappet 18 and an actuator 24. Tappet 18 has a reduced diameter portion 20 passing through an opening 21 in a support 22. The support 22 is fixed to a frame 14. Typically, the frame 14 may be slidably mounted to a body member of a vehicle (not shown) with the disc 12 fixed for rotation with a wheel of the vehicle.

Referring to FIG. 2, the actuator 24 is housed within a circumferentially extending recess 23 in a surface of the support 22 which defines the opening 21. The actuator 24 comprises a first piezo-electric device 26, retaining means in the form of a ratchet member 28, resilient biasing means in the form of a spring 32, and a second piezo-electric device 34.

The first piezo-electric device 26 is disposed between the support 22 and the reduced diameter portion 20, abutting a first surface 25 of the recess 23, which surface faces towards the direction of actuation of the brake 10 (to the left as shown in FIG. 2). The ratchet member 28 has a sharp edge 30 for engaging the reduced diameter portion 20, permitting movement of the tappet 18 in the direction of actuation and resisting movement of tappet 18 in the opposite direction by biting into the reduced diameter portion 20. The spring 32 biases the ratchet member 28 into engagement with the reduced diameter portion 20.

The second piezo-electric device 34 is disposed between the support 22 and the reduced diameter portion 20, in abutment with the ratchet member 28. The second piezo-electric device 34 abuts a second surface 27 of the recess 23, which surface faces away from the direction of actuation of the brake 10.

The first and second piezo-electric devices 26, 34 extend around the reduced diameter portion 20 and may comprise a plurality of piezo-electric elements. The piezo-electric devices 26, 34 respond rapidly to application and removal of an energising voltage (or current) controlled by a controller, for example a microprocessor (not shown).

Ratchet member 28 is a self-locking device. Many suitable mechanical devices will be apparent to the skilled person.

In use, a voltage is applied to the first piezo-electric device 26 causing it to expand, acting against the support 22. The action of the first piezo-electric device 26 against the first surface 25 applies force to the reduced diameter portion 20 so as to move the tappet 18 in the direction of actuation. Removal of the voltage causes the first piezo-electric device 26 to contract, removing force between the support 22 and the tappet 18.

Further application of the voltage to the first piezo-electric device 26 results in further application of force to the tappet 18 to further actuate the brake 10. Thus, although each time the first piezo-electric device 26 is expanded only a small movement of tappet 18 is possible, much greater movement is possible by repeatedly expanding and contracting the first piezo-electric device 26. A high frequency of application and removal of the voltage results in rapid actuation of the brake 10.

It will be appreciated that a plurality of first piezo-electric devices 26, disposed between the housing and the shaft may be used to provide the actuating force.

To release the brake 10, a voltage is applied to the second piezo-electric device 34 causing it to expand and urge the ratchet member 28 to overcome the biasing action of the spring 32 so as to move the ratchet member 28 out of engagement with the reduced diameter portion 20. The action of the first piezo-electric device 26 against the second surface 27 applies force to the reduced diameter portion 20 so as to move the tappet 18 in the opposite direction (to the right in FIG. 2). Further movement to release the brake 10 is provided by repeatedly expanding and contracting the second piezo-electric device 34.

The controller adjusts the level of the voltages applied to the first and second piezo-electric devices 26, 34, in response to sensor signals from the brake, to ensure that the level of force applied to the tappet 18 is maintained during braking and to enable the position of the tappet 18 on release of the brake to be adjusted to compensate for wear of the brake pads 16.

Referring now to FIG. 3a, a further brake actuating means comprises a shaft 40 passing through an opening 41 in a structural element 42. Typically, the structural element 42 forms part of a brake and is similar to the support 22 of FIG. 1. Shaft 40 forms part of a tappet. A plurality of sets of piezo-electric devices, 43, 44, 45, in this example three, are disposed between a radially outer surface of the shaft 40 and a radially inner surface of the structural element 42 defining the opening 41.

The sets of piezo-electric devices 43, 44, 45 respond rapidly to application and removal of an energising voltage. A controller (not shown), for example a microprocessor, is provided for controlling the application and removal of the energising voltage.

In use, a first set of piezo-electric devices 43 are energised so as to change shape in a predetermined manner so as to act against the structural element 42 and apply force to the shaft 40 tending to move the shaft 40 in an axial direction as shown in FIG. 3a. Subsequently, as shown in FIG. 3b, a second set of piezo-electric devices 44 are energised so as to change shape in a predetermined manner so as to apply force to the shaft 40 in the same direction. The energising voltage is removed from the first set of piezo-electric devices 43 so that they return to their original shape, but the shaft 40 is prevented from moving in the opposite direction due to force applied by the second set of piezo-electric devices 44. A third set of piezo-electric devices 45 is then energised to apply force to the shaft 40, and the energising voltage removed from the second set of piezo-electric devices 44. The first set of piezo-electric devices 43 are then energised again, and the sequence repeated for as long as application of force is required.

Although each time a set of piezo-electric devices 43, 44, 45 is energised it is only possible to move the shaft 40 a small distance, repeated energisation and de-energisation of the sets of piezo-electric elements 43, 44, 45, in sequence, results in a sustained application of force and/or much larger movement. The rapid response characteristics of the piezo-electric devices 43, 44, 45, enable a high frequency of application and removal of the voltage to be used to provide rapid actuation of the brake.

In a modified embodiment shown in FIG. 4a, the shaft 40 and opening 41 are substantially coaxially aligned. A plurality of piezo-electric devices, shown generally as 47 are disposed between the radially inner surface, defining the opening 41 in structural element 42, and the radially outer surface of shaft 40. First and second sub-sets of piezo-electric devices 48, 49 are arranged to change size and/or shape when energised so as to act against the radially inner surface of structural element 42 applying a torque to the shaft 40. A large angle of rotation or sustained application of torque is provided by repeated energisation, in sequence, of the sub-sets of piezo-electric devices 48, 49.

Some of the plurality of piezo-electric devices 47 may be arranged to provide axial force to the shaft 40 and others arranged to provide torque so that a combined axial and rotational force can be provided by selectively expanding the piezo-electric devices, 47, 48, 49.

Additionally, some of the piezo-electric devices 47 may be arranged to provide lateral force in a first radial direction, and others to provide lateral force in a second radial direction perpendicular to the first radial direction. Application of the lateral forces in either or both radial directions facilitates adjustment of the position of the shaft 40 relative to the structural element 42.

Rapid response characteristics of the piezo-electric devices 47, 48, 49, enable a high frequency of application and removal of the voltage to be used to provide rapid actuation and adjustment of the brake. Actuation and adjustment is controlled by the controller through the timing and levels of voltages applied to the piezo-electric devices 47, 48, 49, in response to signals from sensors (not shown) on the brake.

Referring now to FIG. 5, a further brake arrangement 50 comprises a brake disc 51 and brake pads 52 operable to clamp the disc 51 to apply a braking force thereto. The brake pads 52 are actuated by expansion of first and second groups of piezo-electric devices 56, 58 disposed between laterally outer surfaces of the brake pads 52 and laterally inner surfaces of a housing 54. The piezo-electric devices 56, 58 respond rapidly to an applied voltage, which is controlled by a controller, for example a microprocessor (not shown). Each group of piezo-electric devices 56, 58 is connected to an oscillating voltage supply. A phase difference is provided between the voltage supplied to the first group 56 and the voltage supplied to the second group 58.

In use, the first group of piezo-electric devices 56 is expanded to apply force to the brake pads 52 as the applied voltage rises. Expansion of the second group of piezo-electric devices 58 to apply force occurs later, due to the phase difference between the applied voltages, and while the first group of piezo-electric devices 56 contracts as the applied voltage falls. Force to the brake pads 52 is sustained by the repeated alternate expansion and contraction of the groups of piezo-electric devices 56, 58, in sequence, due to the phase-shifted oscillating voltages. Rapid response characteristics of the piezo-electric devices 56, 58, enable a high frequency of oscillation of the voltage to be used to provide rapid actuation of the brake.

It will be appreciated that more than two groups of piezo-electric devices may be used, the groups being expanded and contracted in sequence by phase-shifted oscillating voltages. FIG. 6 is a graph showing the amplitude of the force applied 66 as a function of time 67 in a configuration comprising four groups of piezo-electric devices connected to phase-shifted oscillating voltages. The amplitudes of the forces applied by each group of piezo-electric devices is shown by the four lines 61, 62, 63, 64. The combined effect is to produce an actuating force shown by line 65 which is sustained with only a small variation 68 over a period of time.

Thus the braking force may be sustained by making use of the dynamic characteristics of the piezo-electric devices. The sequential expansion of the groups of piezo-electric devices, due to the phase-shifted voltage supplies, ensures that during actuation of the brake, the actuating force is close to the maximum available.

The level of the voltage applied to the piezo-electric devices in the groups 56, 58, is controlled by the controller in response to feedback signals from the brake to the controller. Each piezo-electric device in the groups 56, 58 applies force to an associated area of brake pad 52. By adjusting the level of the voltage applied to a piezo-electric device in a group 56, 58, the force applied to the associated area of the brake pad 52 may be adjusted, thereby adjusting the pressure distribution across the brake pad 52 to compensate for the effects of pad wear.

1. An apparatus for actuating a brake comprising:
a force transmission means that transmits force to a friction pad of a brake;
at least one piezo-electric device operable when energized to change at least one of shape and size so as to apply a force to the force transmission means in a first direction for actuating the brake; and
a retaining means operable to resist movement of the force transmission means in a second direction opposite the first direction, wherein the retaining means is a ratchet device.

2. An apparatus as defined in claim 1, wherein, wherein the ratchet device comprises a mechanical device.

3. An apparatus as defined in claim 2, wherein the mechanical device comprises a ratchet member and a biasing means that biases the ratchet member into engagement with the force transmission means for resisting movement thereof.

4. An apparatus as defined in claim 3, wherein the ratchet member has a sharp edge for engaging the force transmission means.

5. An apparatus as defined in claim 3, wherein expansion of the piezo-electric device causes the ratchet member to move out of engagement with the force transmission means, and wherein contraction of the piezo-electric device permits the biasing means to move the ratchet member into engagement with the force transmission means.

6. An apparatus as defined in claim 1, wherein the apparatus comprises a support, wherein a portion of the force transmission means passes through an opening in the support, the piezo-electric device being interposed between said portion and the support to act against the support when applying force to the force transmission means.

7. An apparatus as defined in claim 1, wherein the apparatus further comprises at least one oppositely-acting piezo-electric device operable to apply force to move the force transmission means in the second direction.

8. An apparatus as defined in claim 7, wherein the ratchet device comprises a ratchet member and a biasing means that applies a biasing force to bias the ratchet member into engagement with the force transmission means so as to resist movement thereof, wherein the at least one oppositely-acting piezo-electric device is also operable to overcome the biasing force.

9. An apparatus for actuating a brake comprising force transmission means for transmitting force to a friction pad of a brake, a structural element, a shaft of the force transmission means passing through an opening in the structural element, and a plurality of piezo-electric devices being interposed between the shaft and the structural element, such that when energized, the piezo-electric devices change shape and/or size so as to act against the structural element and cause a force to be applied to the force transmission means in a direction for actuating the brake, and in a tangential and/or radial direction with respect to the shaft, the piezo-electric devices further being operable to resist movement of the force transmission means in an opposite direction.

10. An apparatus for actuating a brake as defined in claim 9, wherein the piezo-electric devices are operable to apply a force to move the force transmission means in the opposite direction.

11. An apparatus for actuating a brake as defined in claim 9, wherein sub-sets of the piezo-electric devices are arranged to change size and/or shape when energized so as to act against a radially inner surface of the structural element, the sub-sets of piezo-electric devices capable of being repeatedly energized in sequence so as to apply a large angle of rotation or sustained application of torque to the shaft.

12. An apparatus for actuating a brake as defined in claim 9, wherein some of the plurality of piezo-electric devices are arranged to provide axial force to the shaft, and others arranged to provide torque to the shaft, selective expansion of the piezo-electric devices enabling a combined axial and rotational force to be applied to the shaft.

13. An apparatus for actuating a brake as defined in claim 9, wherein a first group of the plurality of piezo-electric devices are arranged to provide a lateral force in a first radial direction, and a second group of the plurality of piezo-electric devices are arranged to provide a lateral force in a second radial direction perpendicular to the first radial direction.

14. An apparatus for actuating a brake, comprising:
a plurality of piezo-electric devices, each device being associated with a respective one of a plurality of device groups, wherein the devices in each group are energizable together; and
an oscillating power supply connected to the plurality of piezo-electric devices, wherein the power supply has a phase difference between power supplied to associated groups, to change size and/or shape in groups; sequentially; to apply force directly to a brake pad so as to actuate a brake.

15. An apparatus for actuating a brake as defined in claim 14, wherein each group of piezo-electric devices is arranged to apply a force to an associated area of the brake pad so as to vary the force across the brake pad.
